(19) United States
(12) Patent Application Publication
(10) Pub. No.: US 2005/0163598 A1
(43) Pub. Date: Jul. 28, 2005

(54) Method for carrying substrate

(75) Inventors: Mitsuhiro Yuasa, Tokyo (JP); Koji Homma, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: Tokyou Electron Limited, Minato-Ku (JP)

(21) Appl. No.: 10/505,435

(22) PCT Filed: Dec. 26, 2002
(86) PCT No.: PCT/JP02/13680

(30) Foreign Application Priority Data
Feb. 27, 2002 (JP) 2002-51782
Feb. 27, 2002 (JP) 2002-51783

(51) Int. Cl. B65G 1/00

(52) U.S. Cl. 414/217

(57) ABSTRACT

The present invention relates to a method of conveying a substrate that can convey even a thinned substrate while maintaining its flatness and prevents particles from adhering to the substrate, wherein the step of a conveyor attaching a third substrate holding mechanism to the substrate with a first substrate holding mechanism holding the substrate, the step of driving the third substrate holding mechanism so as to hold the substrate by the conveyor while a first base is holding the substrate, and thereafter canceling the holding of the substrate by the first substrate holding mechanism and jetting out fluid from a first fluid jetting mechanism, the step of conveying the substrate from the first base to a second base and attaching the substrate to a second substrate holding mechanism, and the step of driving the second substrate holding mechanism so as to hold the substrate by the second base while the third base is holding the substrate, and thereafter jetting out fluid from a second fluid jetting mechanism and canceling the holding of the substrate by the third substrate holding mechanism are provided.

### TECHNICAL FIELD

The present invention relates to methods of conveying a substrate, and particularly to a method of conveying a substrate suitable for conveying a substrate whose thickness is reduced by backgrinding.

### BACKGROUND ART

Generally, semiconductor device manufacturing processes are complicated, and in each process, a wafer (substrate) is conveyed to a manufacturing device performing the process so that predetermined processing is performed. Accordingly, in semiconductor manufacturing plants, conveyors conveying wafers between semiconductor manufacturing devices are installed.

This type of substrate conveyor is disclosed in, for instance, Japanese Laid-Open Patent Application No. 4-157751. The conveyor disclosed in this gazette attracts (chucks) a wafer by a Coulomb force so that the wafer adheres thereto. Then, a method that conveys the wafer from a first position to a second position in the following procedure has been employed.

That is, first, a conveying fork is moved to the first position, and the wafer is attached on the conveying fork. Then, voltage is supplied to a wafer holding part (an electrostatic chuck) provided on the conveying fork, so that the attached wafer is held by a Coulomb force.

Next, the conveying fork holding the wafer is moved to the second position, and the voltage application is stopped so as to cancel the electrostatic chucking of the wafer by the wafer holding part. Next, a wafer holding part provided at the second position is driven so as to hold the wafer on a conveying fork at the second position.

By the way, in recent years, as electronic apparatuses such as portable apparatuses have been reduced in size and thickness, semiconductor devices have also been reduced in thickness. Therefore, efforts have been made to reduce the thickness of semiconductor devices by performing grinding (backgrinding) on the back face (the face on the side opposite to the circuit-formation face) of wafers.

However, in the case of conveying the above-described conveyor using this thinned wafer, when the wafer is moved from the first position to the conveying fork and when the wafer is moved from the conveying fork to the second position, there exist time intervals when no force (such as Coulomb force) for maintaining the flatness of the wafer is exerted on the wafer.

In the thinned wafer as described above, the back face has no interconnections etc. formed thereon as opposed to the circuit-formation face (where a large number of metal films due to interconnections etc. are formed). Therefore, stress differs between the circuit-formation face and the back face. Accordingly, the thinned wafer is in a state to warp easily. Therefore, if there exists a time interval when no force to hold the wafer is exerted as described above, warping or curving may occur to the wafer at this time, thus causing a problem in that processing to be performed after the conveyance may not be performed satisfactorily.

Further, in the conveyor, the wafer holding part (electrostatic chuck) of the conveying fork comes into direct contact with the wafer. Therefore, dust (particles etc.) adheres to the wafer holding part so as to reduce the attraction adhesion force of the electrostatic chuck. Further, when the amount of particle adhesion increases, the particles from the wafer holding part adhere to the wafer, thus causing a problem in that the wafer becomes contaminated. These problems occur equally to the wafer holding parts provided at the first position and the second position.

### DISCLOSURE OF THE INVENTION

A general object of the present invention is to provide a method of conveying a substrate in which the above-described prior art disadvantages are eliminated.

A more specific object of the present invention is to realize a method of conveying a substrate that can convey even a thinned substrate while maintaining flatness and prevent particles from adhering to the substrate.

In order to achieve these objects, according to the present invention, in a method of conveying a substrate that conveys the substrate from a first base including a first substrate holding mechanism and a first fluid jetting mechanism to a second base including a second substrate holding mechanism using a conveyor including a third substrate holding mechanism and a second fluid jetting mechanism, the step of the conveyor attaching the third substrate holding mechanism to the substrate with the first substrate holding mechanism holding the substrate, the step of driving the third substrate holding mechanism so as to hold the substrate by the conveyor while the first base is holding the substrate, and thereafter canceling the holding of the substrate by the first substrate holding mechanism and jetting out fluid from the first fluid jetting mechanism, the step of conveying the substrate from the first base to the second base and attaching the substrate to the second substrate holding mechanism, and the step of driving the second substrate holding mechanism so as to hold the substrate by the second base while the third base is holding the substrate, and thereafter jetting out fluid from the second fluid jetting mechanism and canceling the holding of the substrate by the third substrate holding mechanism are provided.

According to this method of conveying a substrate, at the time of canceling the holding of the substrate by the first substrate holding mechanism, fluid is jetted out from the first fluid jetting mechanism. Accordingly, dust (particles etc.) adhering to the first substrate holding mechanism is removed by the jet of fluid. Likewise, at the time of canceling the holding of the substrate by the third substrate holding mechanism, fluid is jetted out from the second fluid jetting mechanism. Accordingly, dust adhering to the third substrate holding mechanism is also removed by the jet of fluid. Thus, it is possible to prevent dust from adhering to each holding mechanism. Therefore, it is possible to prevent the attraction force of each holding mechanism from decreasing over time, and it is possible to prevent dust from each holding mechanism from adhering to the substrate.

Further, according to the above-described invention, at the time of transferring the substrate from the first base to the conveyor, the third substrate holding mechanism is driven so as to hold the substrate by the conveyor while the first base is holding the substrate, and thereafter, the holding of the substrate by the first substrate holding mechanism is canceled. Accordingly, a state where an attraction force is constantly applied to the substrate is maintained.

Further, at the time of transferring the substrate from the conveyor to the second base, the second substrate holding mechanism is driven so as to hold the substrate by the second base while the conveyor is holding the substrate, and thereafter, the holding of the substrate by the third substrate holding mechanism is canceled.

Accordingly, an attraction force is also applied to the substrate constantly at the time of transferring the substrate from the conveyor to the second base. This makes it possible to prevent warping or curving from occurring to the substrate, so that it is possible to maintain the flatness of the substrate at the time of conveyance.

In order to achieve the above-described objects, according to the present invention, the step of cleaning the third substrate holding mechanism provided to the conveyor may be further provided in the above-described method of conveying a substrate.

According to the present invention, by providing the step of cleaning the third substrate holding mechanism provided to the conveyor, it can be ensured that dust adhering to the third substrate holding mechanism that directly conveys the substrate is cleaned off. Accordingly, it can be ensured that dust from the third substrate holding mechanism is prevented from adhering to the substrate, and that the dust is prevented from adhering to the first and second holding mechanisms.

Further, in order to achieve the above-described objects, in the above-described method of conveying a substrate according to the present invention, the substrate can be held by the first substrate holding mechanism after being subjected to backside etching.

The present invention is effective when applied to a substrate that is subject to warping as a result of reduction in its thickness by backgrinding.

Further, in order to achieve the above-described objects, in the above-described method of conveying a substrate according to the present invention, at least one of the first and second bases and the conveyor are provided in reduced pressure chambers, and the substrate holding mechanism provided to the base provided in the reduced pressure chamber and the third substrate holding mechanism can be electrostatic chucks.

According to the present invention, by letting the third substrate holding mechanism be an electrostatic chuck, even when either one of the first and second bases and the conveyor are provided in the reduced pressure chambers, the substrate can be conveyed with reliability.

Further, in order to achieve the above-described objects, according to the present invention, in a method of conveying a substrate that conveys the substrate from a first base including a first substrate holding mechanism to a second base including a second substrate holding mechanism using a conveyor including a third substrate holding mechanism, the step of the conveyor attaching the third substrate holding mechanism to the substrate with the first substrate holding mechanism holding the substrate, the step of driving the third substrate holding mechanism so as to hold the substrate by the conveyor while the first base is holding the substrate, and thereafter canceling the holding of the substrate by the first substrate holding mechanism, the step of conveying the substrate from the first base to the second base and attaching the substrate to the second substrate holding mechanism, and the step of driving the second substrate holding mechanism so as to hold the substrate by the second base while the third base is holding the substrate, and thereafter canceling the holding of the substrate by the third substrate holding mechanism are provided.

According to the present invention, at the time of transferring the substrate from the first base to the conveyor, the third substrate holding mechanism is driven so as to hold the substrate by the conveyor while the first base is holding the substrate, and thereafter, the holding of the substrate by the first substrate holding mechanism is canceled. Accordingly, a state where a holding force is constantly applied to the substrate is maintained.

Further, at the time of transferring the substrate from the conveyor to the second base, the second substrate holding mechanism is driven so as to hold the substrate by the second base while the conveyor is holding the substrate, and thereafter, the holding of the substrate by the third substrate holding mechanism is canceled. Accordingly, a holding force is also applied to the substrate constantly at the time of transferring the substrate from the conveyor to the second base. This makes it possible to prevent warping or curving from occurring to the substrate, so that it is possible to maintain the flatness of the substrate at the time of conveyance.

Further, in order to achieve the above-described objects, according to the present invention, in a method of conveying a substrate that conveys the substrate to a base including a first substrate holding mechanism using a conveyor including a second substrate holding mechanism, the step of the conveyor attaching the substrate on the first substrate holding mechanism of the base with the second substrate holding mechanism holding the substrate, the step of releasing the holding of the substrate by the second substrate holding mechanism after mechanically holding the substrate between the first substrate holding mechanism and the second substrate holding mechanism, and the step of driving the first substrate holding mechanism so as to hold the substrate by the base while the substrate is being held mechanically between the first and second substrate holding mechanisms are provided.

According to the present invention, at the time of transferring the substrate between the conveyor and the base, the holding of the substrate by the second substrate holding mechanism is canceled after holding the substrate mechanically between the first substrate holding mechanism and the second substrate holding mechanism. Accordingly, even when the holding of the substrate by the second substrate holding mechanism is canceled, the substrate is held mechanically by the first and second substrate holding mechanisms. Further, the substrate is transferred to the base by driving the first substrate holding mechanism while the substrate is being held mechanically by the first and second substrate holding mechanisms.

Accordingly, at the time of transferring the substrate between the conveyor and the base, a holding force is constantly applied to the substrate. Therefore, it is possible to prevent warping or curving from occurring to the substrate, and accordingly, it is possible to maintain the flatness of the substrate.

Further, in order to achieve the above-described objects, in the above-described method of conveying a substrate according to the present invention, the substrate may be held by the first substrate holding mechanism after being subjected to backgrinding.

The present invention is effective when applied to a substrate that is subject to warping as a result of reduction in its thickness by backgrinding.

Further, in order to achieve the above-described objects, in the above-described method of conveying a substrate according to the present invention, at least one of the first and second bases and the conveyor are provided in reduced pressure chambers, and the substrate holding mechanism provided to the base provided in the reduced pressure chamber and the third substrate holding mechanism are electrostatic chucks.

According to the present invention, by letting the third substrate holding mechanism be an electrostatic chuck, even when either one of the first and second bases and the conveyor are provided in the reduced pressure chambers, the substrate can be conveyed with reliability.

Further, in order to achieve the above-described objects, in the above-described method of conveying a substrate according to the present invention, at the time of transferring the substrate between the substrate holding mechanism provided to the base provided in the reduced pressure chamber and the third substrate holding mechanism, voltage is applied to the electrostatic chuck from which the substrate is transferred so that an electrostatic force is generated in a direction to separate the substrate therefrom.

According to the present invention, by applying voltage to the electrostatic chuck from which the substrate is transferred so that an electrostatic force is generated in a direction to separate the substrate therefrom, the substrate is easily separable from the electrostatic chuck from which the substrate is transferred, so that the substrate can be transferred with reliability.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a configuration of a processing apparatus to which a wafer conveyor that is an embodiment of the present invention is applied;

FIG. 2 is a diagram for illustrating an operation of the wafer conveyor according to the embodiment of the present invention, showing a state where a wafer has been conveyed to a platform by a transfer arm;

FIG. 3 is a diagram for illustrating the operation of the wafer conveyor according to the embodiment of the present invention, showing a state where the wafer is attached to a stage of the platform;

FIG. 4 is a diagram for illustrating the operation of the wafer conveyor according to the embodiment of the present invention, showing a state where the conveyor is driven so that an electrostatic chuck attached to an arm part is attached on the wafer;

FIG. 5 is a diagram for illustrating the operation of the wafer conveyor according to the embodiment of the present invention, showing a state where the electrostatic chuck of the conveyor has attracted the wafer and a vacuum chuck has jetted out gas;

FIG. 6 is a diagram for illustrating the operation of the wafer conveyor according to the embodiment of the present invention, showing a state where the electrostatic chuck of the conveyor that has attracted the wafer is contained in a load lock chamber;

FIG. 7 is a diagram for illustrating the operation of the wafer conveyor according to the embodiment of the present invention, showing a state where the conveyor has conveyed the wafer to a position above a stage of a processing chamber;

FIG. 8 is a diagram for illustrating the operation of the wafer conveyor according to the embodiment of the present invention, showing a state where the conveyor has attached the wafer to the stage of the processing chamber;

FIG. 9 is a diagram for illustrating the operation of the wafer conveyor according to the embodiment of the present invention, showing a state where the conveyor is separated from the wafer while jetting out gas;

FIG. 10 is a diagram for illustrating the operation of the wafer conveyor according to the embodiment of the present invention, showing a state where the wafer is being processed in the processing chamber;

FIG. 11 is a diagram for illustrating the operation of the wafer conveyor according to the embodiment of the present invention, showing a state where the electrostatic chuck of the conveyor is attached to the processed wafer;

FIG. 12 is a diagram for illustrating the operation of the wafer conveyor according to the embodiment of the present invention, showing a state where the wafer is attracted by and adhered to the electrostatic chuck of the conveyor while gas is being jetted out from an electrostatic chuck of the processing chamber;

FIG. 13 is a diagram for illustrating the operation of the wafer conveyor according to the embodiment of the present invention, showing a state where the electrostatic chuck of the conveyor that has attracted the wafer is contained in a load lock chamber;

FIG. 14 is a diagram for illustrating the operation of the wafer conveyor according to the embodiment of the present invention, showing a state where the conveyor has attached the wafer on the stage of the platform.

FIG. 15 is a diagram for illustrating the operation of the wafer conveyor according to the embodiment of the present invention, showing a state where the electrostatic chuck of the conveyor has stopped attracting the wafer;

FIG. 16 is a diagram for illustrating the operation of the wafer conveyor according to the embodiment of the present invention, showing a state where the conveyor is separated from the wafer while jetting out gas;

FIG. 17 is a diagram for illustrating the operation of the wafer conveyor according to the embodiment of the present invention, showing a state where the electrostatic chuck of the conveyor is being cleaned;

FIG. 18 is an enlarged cross-sectional view of the electrostatic chuck of the conveyor;

FIG. 19 is an enlarged bottom view of the electrostatic chuck of the conveyor;

FIG. 20 is a diagram showing a configuration of a processing apparatus to which a wafer conveyor that is an embodiment of the present invention is applied;

FIG. 21 is a diagram for illustrating an operation of the wafer conveyor according to the embodiment of the present invention, showing a state where the wafer has been conveyed to a platform by a transfer arm;

FIG. 22 is a diagram for illustrating the operation of the wafer conveyor according to the embodiment of the present invention, showing a state where the wafer is attached to a stage of the platform;

FIG. 23 is a diagram for illustrating the operation of the wafer conveyor according to the embodiment of the present invention, showing a state where the conveyor is driven so that an electrostatic chuck attached to an arm part is moved onto the wafer;

FIG. 24 is a diagram for illustrating the operation of the wafer conveyor according to the embodiment of the present invention, showing a state where the electrostatic chuck of the conveyor has attracted the wafer;

FIG. 25 is a diagram for illustrating the operation of the wafer conveyor according to the embodiment of the present invention, showing a state where the electrostatic chuck of the conveyor that has attracted the wafer is contained in a load lock chamber;

FIG. 26 is a diagram for illustrating the operation of the wafer conveyor according to the embodiment of the present invention, showing a state where the conveyor has conveyed the wafer to a position above a stage of a processing chamber;

FIG. 27 is a diagram for illustrating the operation of the wafer conveyor according to the embodiment of the present invention, showing a state where the conveyor has attached the wafer to the stage of the processing chamber (part I);

FIG. 28 is a diagram for illustrating the operation of the wafer conveyor according to the embodiment of the present invention, showing a state where the conveyor has attached the wafer to the stage of the processing chamber (part II);

FIG. 29 is a diagram for illustrating the operation of the wafer conveyor according to the embodiment of the present invention, showing a state where the conveyor has attached the wafer to the stage of the processing chamber (part III); and

FIG. 30 is a diagram for illustrating the operation of the wafer conveyor according to the embodiment of the present invention, showing a state where the electrostatic chuck of the conveyor is separated from the wafer.

### BEST MODE FOR CARRYING OUT THE INVENTION

A description is given below, with reference to the drawings, of embodiments of the present invention.

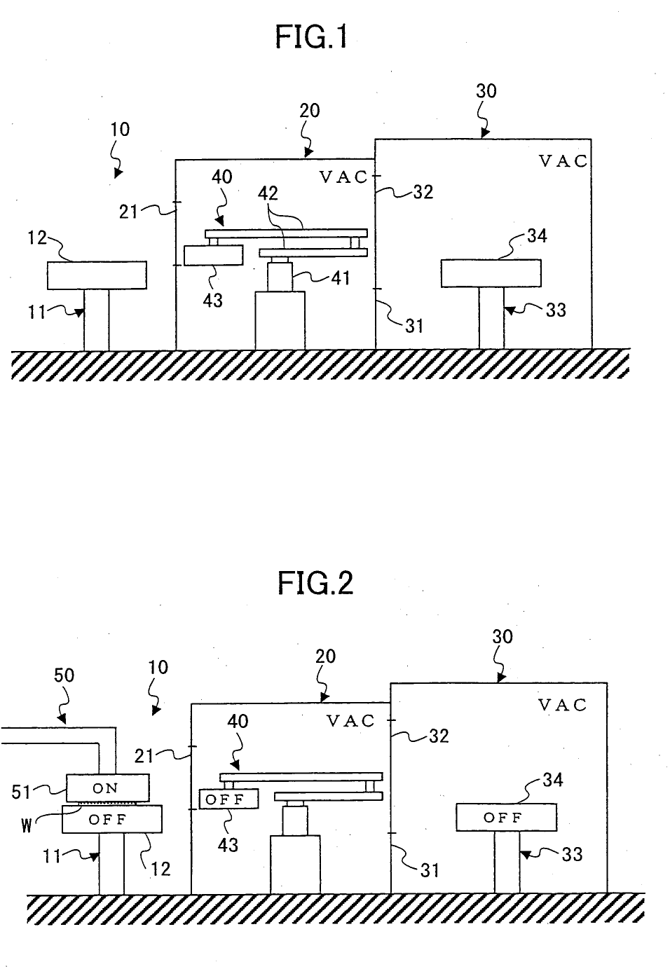

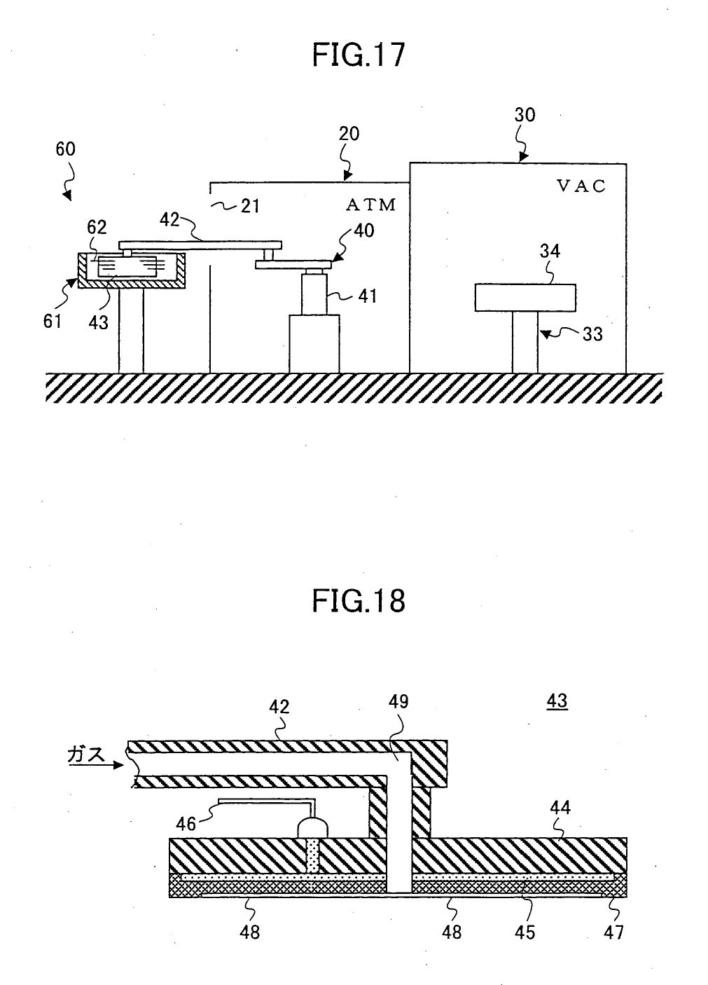

FIG. 1 is a diagram showing a configuration of a processing apparatus used in a method of conveying a substrate that is a first embodiment of the present invention. The processing apparatus is for performing a variety of processes for semiconductor manufacturing on a wafer W, and is composed mainly of a platform 10, a load lock chamber 20, processing chambers 30, a cleaning chamber 60 (shown in FIG. 17), etc. The processing apparatus includes the multiple processing chambers 30 for performing backside etching, dicing, etc., but only one of the processing chambers 30 is shown in the drawings for convenience of graphical representation.

The platform 10 includes a stage 11 common to the multiple processing chambers 30. The wafer W, after being processed in one of the processing chambers 30, is attached to the stage 11 provided to the platform 10, and thereafter, is conveyed to the next processing chamber 30. This platform 10 is placed in an air atmosphere (hereinafter referred to as ATM).

A vacuum chuck 12 for attaching the wafer W is provided to the stage 11 provided to the platform 10. The vacuum chuck 12 is connected to a jet/suction device that is not graphically represented.

At the time of attachment of the wafer W, the jet/suction device is set to a suction mode so that the wafer W is attracted. As a result, the wafer W is held against the vacuum chuck 12 (the suction force serves as the force to attract the wafer W). On the other hand, at the time of taking out (detaching) the wafer W, the jet/suction device is set to a jet mode so that a cleaning gas (for instance, an inert gas) is jetted out toward the wafer W.

This makes it possible to detach the wafer W easily from the vacuum chuck 12 and to blow away dust (particles etc.) adhering to the wafer W by the jet of gas at the time of detachment of the wafer W. Accordingly, it is possible to prevent deficiencies due to the particles. adhering to the wafer W from occurring in the subsequent processes.

The load lock chamber 20 is connected to a vacuum device that is not graphically represented so that the load lock chamber 20 can have a predetermined reduced pressure atmosphere (hereinafter referred to as VAC) inside. Further, a shutter 21 is provided to the wall of the load lock chamber 20 opposite the platform 10. The shutter 21, which can be opened and closed, hermetically seals the load lock chamber 20 in the closed state. Accordingly, the load lock chamber 20 can have the VAC as described above even with the shutter 21. A conveyor 40 is provided inside the load lock chamber 20.

The conveyor 40 is formed of, for instance, a robot with multiaxial degrees of freedom having an elevation part 41 and an arm part 42. An electrostatic chuck 43 is provided to the end portion of the arm part 42. The elevation part 41 moves the arm part 42 up and down. The arm part 42 moves the electrostatic chuck 43 horizontally. Thereby, the conveyor 40 can move the electrostatic chuck 43 to any position.

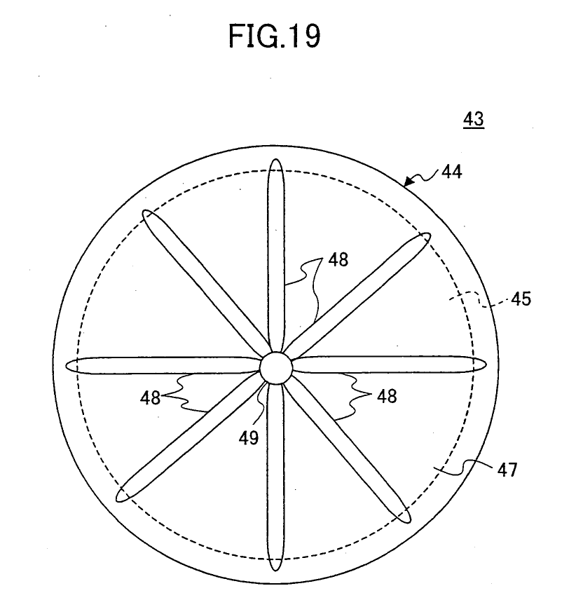

Here, a description is given, with reference to FIGS. 18 and 19, of the details of the electrostatic chuck 43. FIG. 18 is a cross-sectional view of the electrostatic chuck 43, and FIG. 19 is a bottom view of the electrostatic chuck 43.

The electrostatic chuck 43 is composed of a chuck main body 44, and an electrostatic attraction adhesion electrode 45 and multiple groove parts 48 provided therein. Voltage is applied to the electrostatic attraction adhesion electrode 45 by an interconnection 46. The wafer W is attracted and adhered by a Coulomb force generated by the voltage application (the Coulomb force serves as a force to attract the wafer W).

The multiple groove parts 48 are provided radially from the center on an attraction adhesion face 47 to which the wafer W is attracted to adhere. The groove parts 48 are connected on their center position side of the attraction adhesion face 47. This connection part is connected to a jet channel 49. As shown in FIG. 18, the jet channel 49 is formed inside the chuck main body 44 and the arm part 42 so as to have its end connected to a gas supply apparatus (not graphically represented) that jets out (highly stable) gas (such as an inert gas etc.).

At the time of attachment of the wafer W, the electrostatic chuck 43 of the above-described configuration has a voltage applied to the electrostatic attraction adhesion electrode 45 as described above. Thereby, an electrostatic force is generated in the electrostatic attraction adhesion electrode 45, so that the wafer W is attracted and adhered to the electrostatic chuck 43 by this electrostatic force. At this point, the gas supply apparatus is stopped, so that no gas is jetted out from the groove parts 48. Accordingly, the wafer W is prevented from being detached from the electrostatic chuck 43 by gas.

On the other hand, at the time of separating the wafer W from the electrostatic chuck 43, the application of voltage to the electrostatic attraction adhesion electrode 45 is stopped, and the gas supply apparatus is started. Thereby, gas is jetted out from the gas supply apparatus into the jet channel 49, so that the gas is jetted out from the groove parts 48.

This makes it possible to detach the wafer W easily from the electrostatic chuck 43 and to blow away dust adhering to the wafer W by the jet of gas at the time of detachment of the wafer W. Accordingly, it is possible to prevent deficiencies due to the particles adhering to the wafer W from occurring in the subsequent processes. The arrangement of the groove parts 48 is not limited to a radial manner, and may be in other shapes (for instance, circular etc.) as long as the dust adhering to the attraction adhesion face 47 and the wafer W is scattered with efficiency.

In the processing chamber 30, for instance, a plasma etching device that is not graphically represented is provided, so that backside etching that performs etching on the back face (the side with no circuits) of the wafer W to reduce its thickness is performed. The processing chamber 30 is connected to the vacuum device that is not graphically represented so that the processing chamber 30 can have a predetermined VAC (reduced pressure atmosphere) inside. Further, a stage 33 for attaching the wafer W is provided inside the processing chamber 30.

The stage 33 includes the same structure as the electrostatic chuck 43 provided to the conveyor 40 described using FIGS. 18 and 19 (hereinafter, the same configurations as those shown in FIGS. 18 and 19 are described, being referred to by the same numerals).

That is, an electrostatic chuck 34 is composed of the chuck main body 44 with the electrostatic attraction adhesion electrode 45 and the multiple groove parts 48 provided therein. Voltage is applied to the electrostatic attraction adhesion electrode 45 by the interconnection 46. The wafer W is attracted and adhered by a Coulomb force generated by the voltage application.

The multiple groove parts 48 are provided radially from the center on the attraction adhesion face 47 on the upper surface of the electrostatic chuck 34. The groove parts 48 are connected to the jet channel 49. Gas is supplied from a gas supply apparatus (not graphically represented) through the jet channel 49, so that the gas is jetted out from the groove parts 48.

At the time of attachment of the wafer W, the electrostatic chuck 34 of the above-described configuration has a voltage applied to the electrostatic attraction adhesion electrode 45, and attracts the wafer W by an electrostatic force generated by this so that the wafer W adheres thereto. At this point, the gas supply apparatus is stopped. On the other hand, at the time of separating the wafer W from the electrostatic chuck 34, the application of voltage to the electrostatic attraction adhesion electrode 45 is stopped and the gas supply apparatus is started, so that gas is jetted out from the groove parts 48.

This makes it possible to detach the wafer W easily from the electrostatic chuck 34. Further, since dust adhering to the wafer W is blown away by the jet of gas, it is possible to prevent deficiencies due to the particles adhering to the wafer W from occurring in the subsequent processes.

Meanwhile, the processing chamber 30 and the load lock chamber 20 are hermetically separated by a partition wall 31. A shutter 32 that can be opened and closed is provided to the partition wall 31. In its closed state, the shutter 32 hermetically seals the load lock chamber 20. Accordingly, the processing chamber 30 can have the VAC even with the shutter 32. The load lock chamber 20 communicates with the processing chamber 30 with the shutter 32 being open.

As shown in FIG. 17, the cleaning chamber 60 includes a cleaning tank 61 filled with cleaning liquid 62. The cleaning chamber 60 is within the movement range of the arm part 42 provided to the conveyor 40, and the position of its placement is selected so as not to hinder the provision of the processing chamber 30. The cleaning liquid 62 filling the cleaning tank 61 can clean the electrostatic chuck 43 of the conveyor 40 as described below.

Thus, by providing the cleaning chamber 60, a part of the dust adhering to the electrostatic chuck 43 which part has not been removed by the jet of gas in each of the electrostatic chucks 34 and 43 can also be cleaned off. Accordingly, the prevention of the occurrence of deficiencies due to the particles adhering to the wafer W can be further ensured.

Next, a description is given, with reference to FIGS. 2 through 17, of example conveyance in which the wafer W is conveyed from the platform 10 to the processing chamber 30, and is again conveyed from the processing chamber 30 to the platform 10 in the processing apparatus of the above-described configuration.

In FIGS. 2 through 17, in each of the chucks 12, 34, and 43, “OFF” indicates a state where its driving is stopped so that no force to attract the wafer W is generated, and “ON” indicates a state where it is being driven so that a force to attract the wafer W is generated.

FIG. 2 shows a state where the wafer W whose backgrinding, a process previous to backside etching performed in the processing chamber 30, is completed is attached to the stage 11 of the platform 10 by a transfer arm 50. The transfer arm 50 has a vacuum chuck 51 on its end.

The wafer W, whose thickness is reduced by backgrinding, is attached on the vacuum chuck 12 of the stage 11 while being held by the vacuum chuck 51. At this point, the vacuum chuck 12 of the stage 11 is stopped (OFF), so that no vacuum suction force is generated. Further, neither the electrostatic chuck 34 nor the electrostatic chuck 43 is driven (OFF), so that no attraction force is generated in either of the chucks 34 and 43. Further, the shutters 21 and 32 are closed, so that each of the chambers 20 and 30 has the VAC. Further, the conveyor 40 is on standby in the load lock chamber 20.

When the wafer W is attached on the vacuum chuck 12 as described above, the vacuum chuck 12 is started (ON) so as to start to suck the wafer W. In this state, the vacuum chuck 51 still maintains the holding of the wafer W.

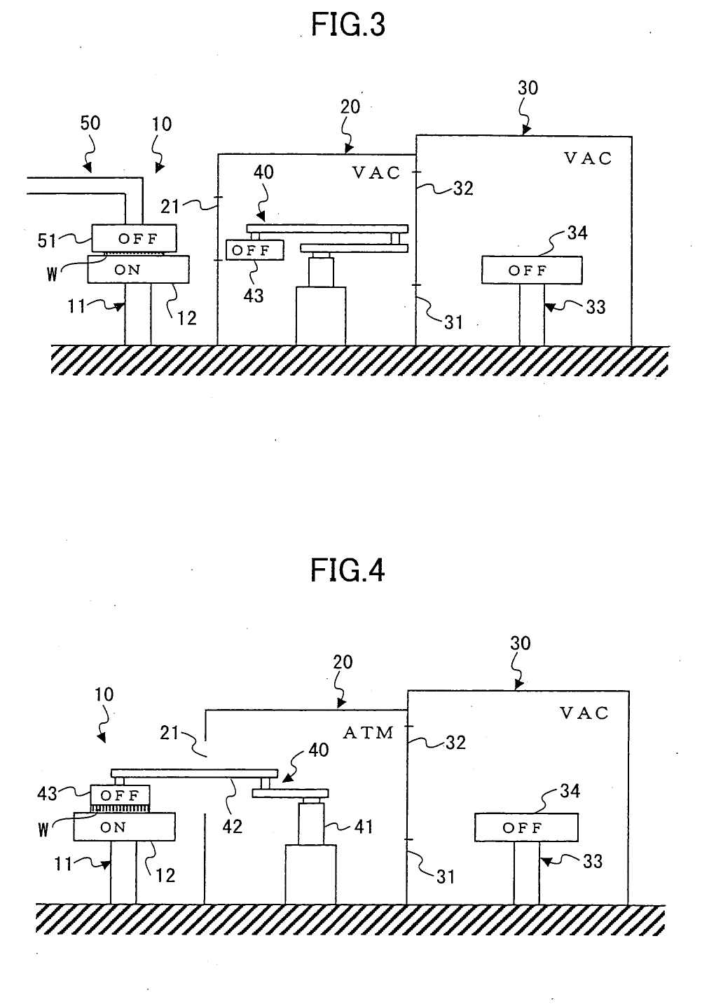

After the vacuum chuck 12 turns ON so that the suction of the wafer W is started, the suction of the wafer W by the vacuum chuck 51 of the transfer arm 50 is stopped (OFF) as shown in FIG. 3. Thereby, the wafer W is transferred from the vacuum chuck 51 of the transfer arm 50 to the vacuum chuck 12 of the stage 11 so as to be held by the vacuum chuck 12.

By the way, the wafer W reduced in thickness by backgrinding is reduced in mechanical strength, and metal interconnections are provided with high density on its circuit-formation face. Accordingly, a substantial difference in stress is generated between its front and back, so that the wafer W is subject to warping.

However, by employing a method that drives the vacuum chuck 12 (ON) to hold the wafer W against the vacuum chuck 12 while the vacuum chuck 51 (the transfer arm 50) is holding the wafer W, and thereafter cancels the holding of the wafer W by the vacuum chuck 51 (OFF) at the time of transferring the wafer W from the transfer arm 50 to the stage 11 as in this embodiment, a state where the suction force of either the vacuum chuck 51 or the vacuum chuck 12 is constantly applied to the wafer W is maintained.

Therefore, it is possible to prevent warping or curving from occurring to the wafer W and maintain the flatness of the wafer W at the time of transferring the wafer W from the transfer arm 50 to the stage 11 of the platform 10. When the wafer W is transferred from the vacuum chuck 51 to the vacuum chuck 12, the vacuum chuck 51 is separated from the wafer W to move again to a backgrinding device.

When the wafer W is attached to the stage 11, the shutter 21 opens after the ATM is created in the load lock chamber 20. Then, the conveyor 40 (the elevation part 41 and the arm part 42) is driven so that the electrostatic chuck 43 is moved onto (attached on) the wafer W held by the stage 11 as shown in FIG. 4. At this point, the electrostatic chuck 43 is in an undriven state (OFF) where no voltage is applied thereto, and the shutter 32 is closed so that the processing chamber 30 has the VAC inside.

When the electrostatic chuck 43 is attached on the wafer W as described above, the electrostatic chuck 43 has a voltage applied to the electrostatic attraction adhesion electrode 45 through the interconnection 46. Thereby, the electrostatic chuck 43 is started (ON), so that the attraction of the wafer W by a Coulomb force is started. In this state, the vacuum chuck 12 still maintains the holding of the wafer W.

After the electrostatic chuck 43 turns ON so that the attraction of the wafer W by the electrostatic chuck 43 is started, the suction of the wafer W by the vacuum chuck 12 of the stage 11 is stopped (OFF). Thereby, the wafer W is transferred from the vacuum chuck 12 of the stage 11 to the electrostatic chuck 43 of the conveyor 40 so as to be held by the electrostatic chuck 43.

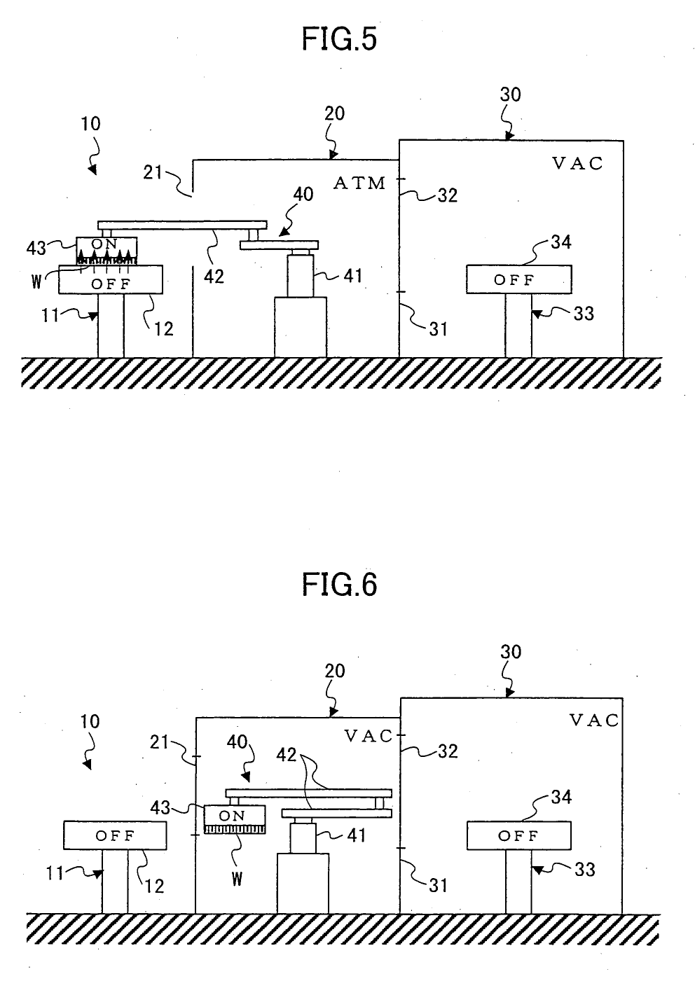

At the same time that the suction of the wafer W by the vacuum chuck 12 of the stage 11 is turned OFF, the jet/suction device supplies gas to the vacuum chuck 12, so that the gas is jetted out from the vacuum chuck 12 to the wafer W as shown in FIG. 5.

As described above, in this embodiment, by employing a method that drives the electrostatic chuck 43 (ON) to hold the wafer W against the electrostatic chuck 43 while the vacuum chuck 12 (the stage 11) is holding the wafer W, and thereafter cancels the holding of the wafer W by the vacuum chuck 12 at the time of transferring the wafer W from the vacuum chuck 12 of the stage 11 to the electrostatic chuck 43 of the conveyor 40, a state where the attraction force of either the vacuum chuck 12 or the electrostatic chuck 43 is constantly applied to the wafer W is maintained.

Therefore, it is possible to prevent warping or curving from occurring to the wafer W and maintain the flatness of the wafer W at the time of transferring the wafer W from the stage 11 to the electrostatic chuck 43 of the conveyor 40.

Further, at the same time that the suction of the wafer W by the vacuum chuck 12 is turned OFF, gas is jetted out from the vacuum chuck 12 to the wafer W. Accordingly, the wafer W is urged toward the electrostatic chuck 43. This prevents the wafer 43 from sticking to the vacuum chuck 12 so as to ensure the transfer of the wafer W to the electrostatic chuck 43.

Further, when the upward movement of the electrostatic chuck 43 creates a minute gap between the wafer W and the vacuum chuck 12, the gas jetted out from the vacuum chuck 12 flows through this minute gap at high speed. Accordingly, dust adhering to the wafer attraction adhesion face of the vacuum chuck 12 and to the wafer W is removed by this high-speed gas.

This makes it possible to prevent the suction force from decreasing over time because of the deposition of dust on the vacuum chuck 12, and to prevent dust from the vacuum chuck 12 from adhering to the wafer W. Further, since it is possible to prevent dust from adhering to the wafer W, it is possible to prevent dust from exerting an adverse effect in the subsequent processes to be performed on the wafer W.

When the wafer W is transferred to the electrostatic chuck 43 as described above, the conveyor 40 is driven to draw the wafer W inside the load lock chamber 20 as shown in FIG. 6. When this drawing is completed, the shutter 21 is closed, and the load lock chamber 20 is caused to have substantially the same VAC as in the processing chamber 30. At this point, the wafer W is held against the electrostatic chuck 43 by a Coulomb force (an electrostatic force). Accordingly, the electrostatic chuck 43 can also hold the wafer W in the VAC with reliability.

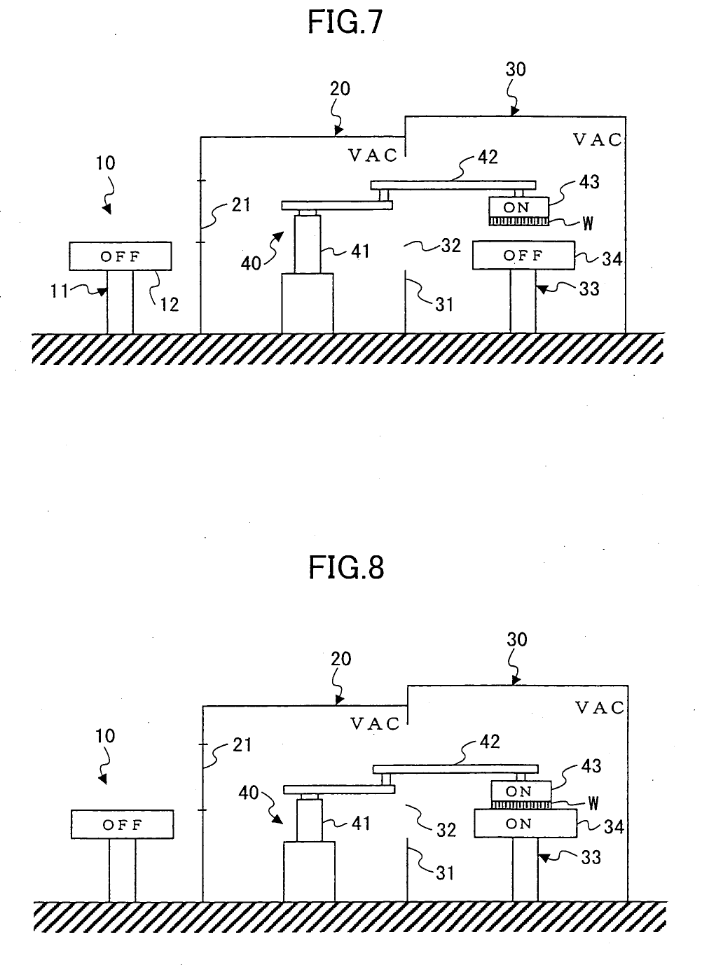

When the load lock chamber 20 has the same VAC inside as the processing chamber 30, the shutter 32 provided to the partition wall 31 separating the load lock chamber 20 and the processing chamber 30 opens. Then, the conveyor 40 is driven again to convey the wafer W held by the electrostatic chuck 43 to a position above the stage 33 of the processing chamber 30 as shown in FIG. 7.

Next, as shown in FIG. 8, the conveyor 40 attaches the wafer W on the electrostatic chuck 34 of the processing chamber 30. When the wafer W is attached on the electrostatic chuck 34, the electrostatic chuck 34 is started (ON) so as to start to attract the wafer W. In this state, the electrostatic chuck 43 of the conveyor 40 still maintains the holding of the wafer W.

Then, after the electrostatic chuck 34 turns ON so as to start to attract the wafer W, the application of voltage to the electrostatic attraction adhesion electrode 45 is stopped, so that the attraction and adhesion of the wafer W by the electrostatic chuck 43 is stopped (OFF). Thus, a method that drives the electrostatic chuck 34 (ON) so as to hold the wafer W against the electrostatic chuck 34 while the electrostatic chuck 43 is holding the wafer W, and thereafter cancels the holding of the wafer W by the electrostatic chuck 43 (OFF) is also employed at the time of transferring the wafer W from the electrostatic chuck 43 to the electrostatic chuck 34.

Thereby, a state where the attraction force of either the electrostatic chuck 43 or the electrostatic chuck 34 is constantly applied to the wafer W is also maintained at the time of transferring the wafer W from the electrostatic chuck 43 to the electrostatic chuck 34. Therefore, it is possible to prevent warping or curving from occurring to the wafer W and maintain the flatness of the wafer W at the time of transferring the wafer W from the conveyor 40 to the stage 33 of the processing chamber 30.

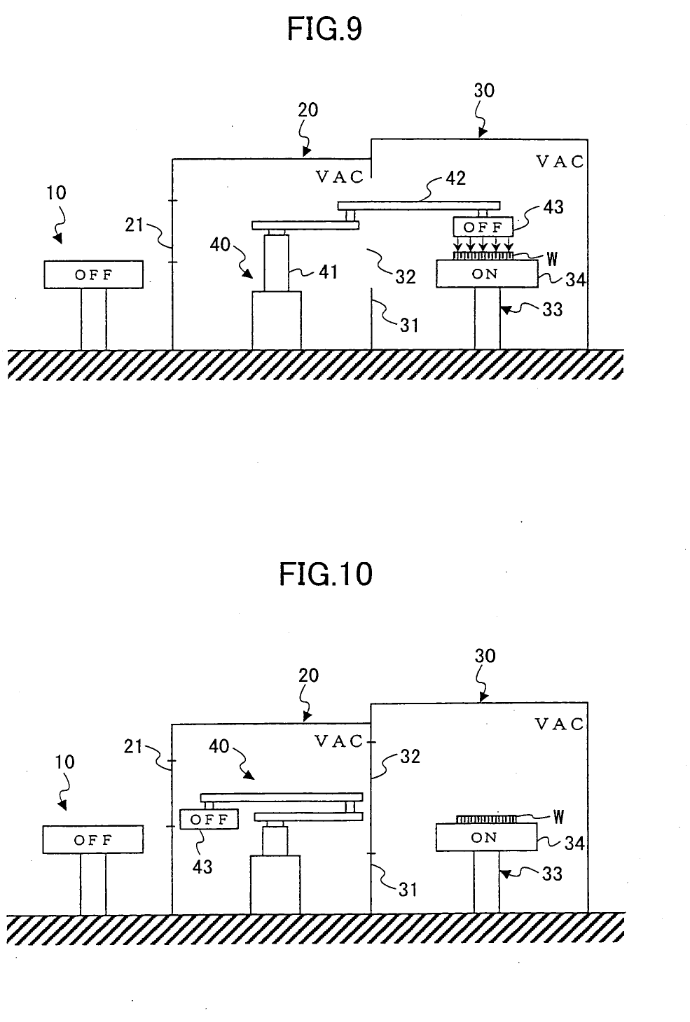

Meanwhile, at the same time that the electrostatic attraction adhesion electrode 45 is turned OFF, the gas supply apparatus connected to the electrostatic chuck 43 is started, so that gas is jetted out through the jet channel 49 from the groove parts 48 toward the wafer W as shown in FIG. 9.

Generally, in the case of an electrostatic chuck, all electric charges are not dissipated immediately after the application of voltage is stopped. Accordingly, a predetermined period of time is required before the electrostatic chuck loses the power to hold the wafer W completely. This results in loss of time in transferring the wafer W, thus causing a decrease in throughput.

However, by jetting out gas from the electrostatic chuck 43 toward the wafer W at the time of transferring the wafer W from the electrostatic chuck 43 to the electrostatic chuck 34 as in this embodiment, it can be ensured that the wafer W is transferred easily from the electrostatic chuck 43 to the electrostatic chuck 34 in a short period of time. Thereby, the throughput of the conveying of the wafer W can be improved.

Further, since the electrostatic chuck 43 holds the wafer W by a Coulomb force, the electrostatic chuck 43 may also attract dust by the Coulomb force. The dust thus attracted adheres to the electrostatic chuck 43. However, when a minute gap is created between the chucks 34 and 43 at the time of the electrostatic chuck 43 being separated from the electrostatic chuck 34, the gas jetted out from the electrostatic chuck 43 flows through this minute gap at high speed. Accordingly, the dust adhering to the electrostatic chuck 43 and the wafer W is removed by this high-speed gas.

This makes it possible to prevent the attraction force from decreasing over time because of the deposition of dust on the electrostatic chuck 43, and to prevent dust from the electrostatic chuck 43 from adhering to the wafer W. Further, since it is possible to prevent dust from adhering to the wafer W, it is possible to prevent dust from exerting an adverse effect in the subsequent processes to be performed on the wafer W.

When the wafer W is transferred from the electrostatic chuck 43 to the electrostatic chuck 34, the gas supply apparatus is stopped so that jetting out gas from the electrostatic chuck 43 is stopped, and the conveyor 40 is driven to move the electrostatic chuck 43 again into the load lock chamber 20 as shown in FIG. 10. Then, the shutter 32 is closed, so that backside etching is performed on the wafer W using the plasma etching device in the processing chamber 30.

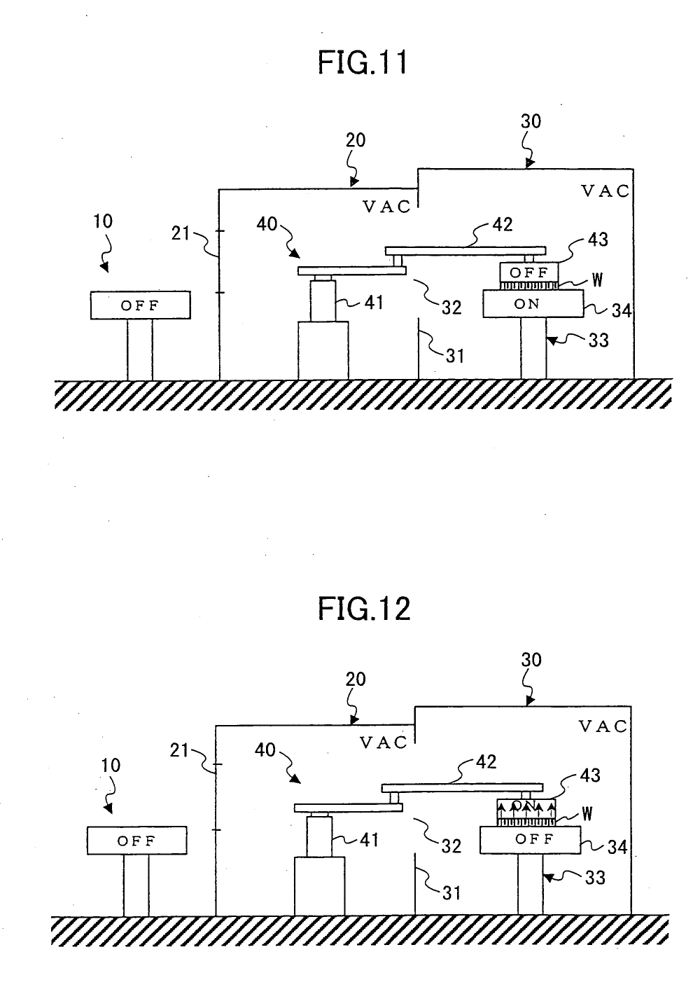

When the backside etching in the processing chamber 30 is completed, the shutter 32 is opened, and the conveyor 40, which has been on standby in the load lock chamber 20, is driven to attach the electrostatic chuck 43 on the wafer W held by the electrostatic chuck 34 as shown in FIG. 11. When the electrostatic chuck 43 is attached on the wafer W, the electrostatic chuck 43 is started (ON) so as to start to attract the wafer W. In this state, the electrostatic chuck 34 of the stage 33 still maintains the holding of the wafer W. Then, after the electrostatic chuck 43 turns ON to start to attract the wafer W, the electrostatic chuck 34 stops the attraction and adhesion of the wafer W (OFF).

Thereby, a state where the attraction force of either the electrostatic chuck 34 or the electrostatic chuck 43 is constantly applied to the wafer W is also maintained at the time of transferring the wafer W from the electrostatic chuck 34 to the electrostatic chuck 43 after the backside etching on the wafer W is completed. Therefore, it is possible to prevent warping or curving from occurring to the wafer W and maintain the flatness of the wafer W.

Meanwhile, at the same time that the electrostatic attraction adhesion electrode 45 of the electrostatic chuck 34 is turned OFF, the gas supply apparatus connected to the electrostatic chuck 34 is started, so that gas is jetted out from the electrostatic chuck 34 toward the wafer W as shown in FIG. 12.

Thus, by jetting out gas from the electrostatic chuck 34 toward the wafer W, it can also be ensured that the wafer W is transferred easily from the electrostatic chuck 34 to the electrostatic chuck 43 in a short period of time, and the throughput of the conveying of the wafer W can also be improved at the time of transferring the wafer W from the electrostatic chuck 34 to the electrostatic chuck 43.

Further, since the electrostatic chuck 34 holds the wafer W by a Coulomb force, the electrostatic chuck 34 may also attract dust by the Coulomb force as described above. However, when a minute gap is created between the chucks 34 and 43 as a result of the movement of the electrostatic chuck 43, the gas jetted out from the electrostatic chuck 34 flows through this minute gap at high speed, thereby removing the dust adhering to the electrostatic chuck 34 and the wafer W.

This makes it possible to prevent the attraction force from decreasing over time because of the deposition of dust on the electrostatic chuck 34, and to prevent dust from the electrostatic chuck 34 from adhering to the wafer W. Further, since it is possible to prevent dust from adhering to the wafer W, it is possible to prevent dust from exerting an adverse effect in the subsequent processes to be performed on the wafer W.

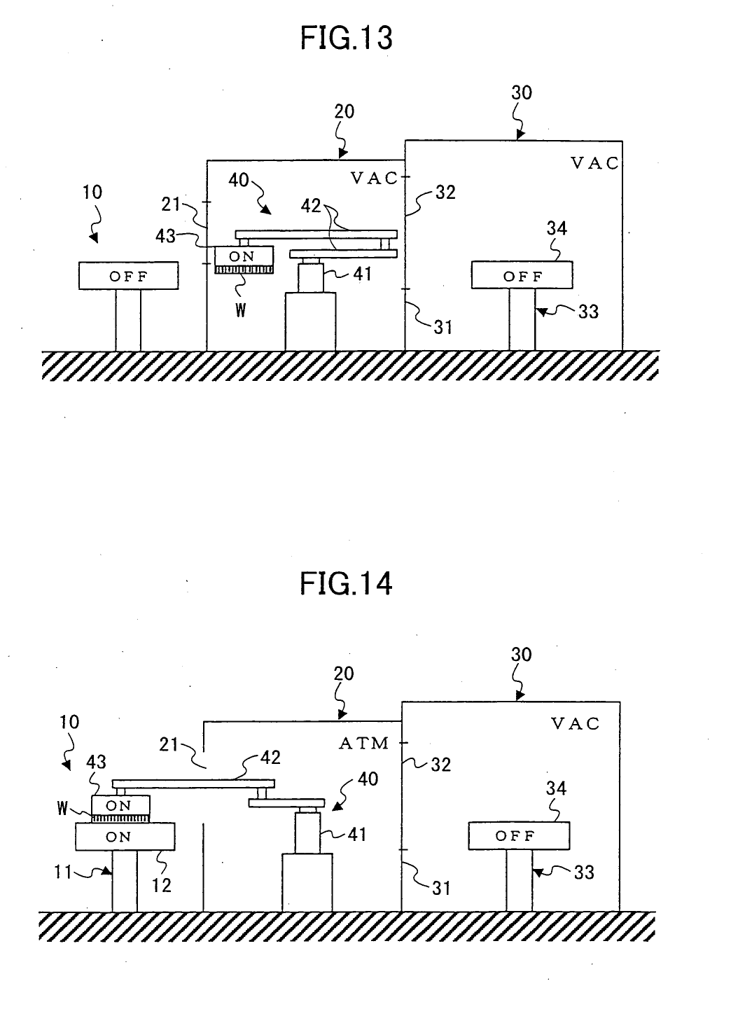

When the wafer W is held against the electrostatic chuck 43 as described above, the conveyor 40 conveys the wafer W into the load lock chamber 20 as shown in FIG. 13. Then, the shutter 32 is closed so as to separate the load lock chamber 20 and the processing chamber 30 again and create the ATM in the load lock chamber 20.

When the ATM is created inside the load lock chamber 20, the shutter 21 of the load lock chamber 20 opens. Then, the conveyor 40 is driven again to convey the wafer W held against the electrostatic chuck 43 to a position above the stage 11 of the platform 10.

Next, as shown in FIG. 14, the conveyor 40 attaches the wafer W on the vacuum chuck 12 of the stage 11. When the wafer W is attached on the vacuum chuck 12, the vacuum chuck 12 is started (ON) so as to start the vacuum suction of the wafer W. In this state, the electrostatic chuck 43 of the conveyor 40 still maintains the holding of the wafer W.

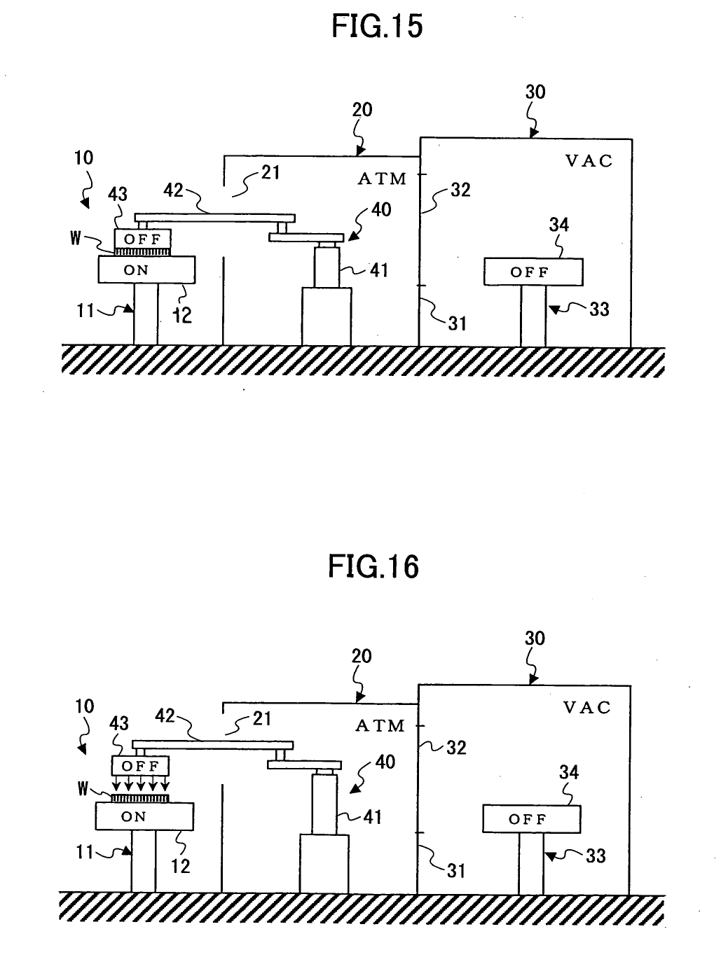

Then, after the vacuum chuck 12 turns ON so as to start to suck the wafer W, the application of voltage to the electrostatic attraction adhesion electrode 45 is stopped, so that the attraction and adhesion of the wafer W is stopped (OFF) in the electrostatic chuck 43 as shown in FIG. 15. Thus, a method that drives the vacuum chuck 12 (ON) so as to hold the wafer W against the vacuum chuck 12 while the electrostatic chuck 43 is holding the wafer W, and thereafter cancels the holding of the wafer W by the electrostatic chuck 43 (OFF) is also employed at the time of transferring the wafer W from the electrostatic chuck 43 to the vacuum chuck 12.

This also makes it possible to prevent warping or curving from occurring to the wafer W and maintain the flatness of the wafer W at the time of transferring the wafer W from the electrostatic chuck 43 to the vacuum chuck 12.

Meanwhile, at the same time that the electrostatic attraction adhesion electrode 45 of the electrostatic chuck 43 is turned OFF, the gas supply apparatus connected to the electrostatic chuck 43 is started, so that gas is jetted out through the jet channel 49 from the groove parts 48 toward the wafer W as shown in FIG. 16.

Thus, by jetting out gas from the electrostatic chuck 43 toward the wafer W, it can also be ensured that the wafer W is transferred easily in a short period of time, and the throughput of the conveying of the wafer W can also be improved at the time of transferring the wafer W from the electrostatic chuck 43 to the vacuum chuck 12.

Further, since the electrostatic chuck 43 holds the wafer W by a Coulomb force, the electrostatic chuck 34 may also attract dust by the Coulomb force as described above. However, when a minute gap is created between the chucks 12 and 43 as a result of the movement of the electrostatic chuck 43, the gas jetted out from the electrostatic chuck 43 flows through this minute gap at high speed, thereby removing the dust adhering to the electrostatic chuck 43 and the wafer W.

This makes it possible to prevent the attraction force from decreasing over time because of the deposition of dust on the electrostatic chuck 43, and to prevent dust from the electrostatic chuck 43 from adhering to the wafer W. Further, since it is possible to prevent dust from adhering to the wafer W, it is possible to prevent dust from exerting an adverse effect in the subsequent processes to be performed on the wafer W.

When the above-described series of operations is completed, the conveyor 40 moves the arm part 42 to the cleaning chamber 60 as shown in FIG. 17. As described above, the cleaning tank 61 filled with the cleaning liquid 62 is provided in the cleaning chamber 60. Then, the conveyor 40 soaks the electrostatic chuck 43 in the cleaning liquid 62.

The cleaning liquid 62 filling the cleaning tank 61 has the function of cleaning off and removing dust (particles etc.) and foreign bodies adhering to the electrostatic chuck 43. Thereby, dust or foreign bodies that have not been completely removed by the gas jetted out from each of the chucks 12, 34, and 43 can also be removed by the cleaning chamber 60. As a result, it is also possible to prevent dust from adhering to the wafer W conveyed by the electrostatic chuck 43.

Here, in addition to the method that soaks the electrostatic chuck 43 in the cleaning liquid 62 as in this embodiment, a mechanical cleaning method using a brush or cloth and a cleaning method using electrostatic attraction adhesion by high voltage can be considered as methods of cleaning the electrostatic chuck 43. However, there is no limitation of cleaning methods as long as dust or foreign bodies adhering to the electrostatic chuck 43 can be removed.

In the above-described first embodiment, a first base recited in CLAIMS corresponds to the stage 11, and a first substrate holding mechanism corresponds to the vacuum chuck 12. Further, a second base recited in CLAIMS corresponds to the stage 33, and a second substrate holding mechanism corresponds to the electrostatic chuck 34. Further, a conveyor recited in CLAIMS corresponds to the conveyor 40, and a third substrate holding mechanism corresponds to the electrostatic chuck 43. However, the present invention is not limited to the above-described embodiment, and is widely applicable as a conveyor conveying the wafer W.

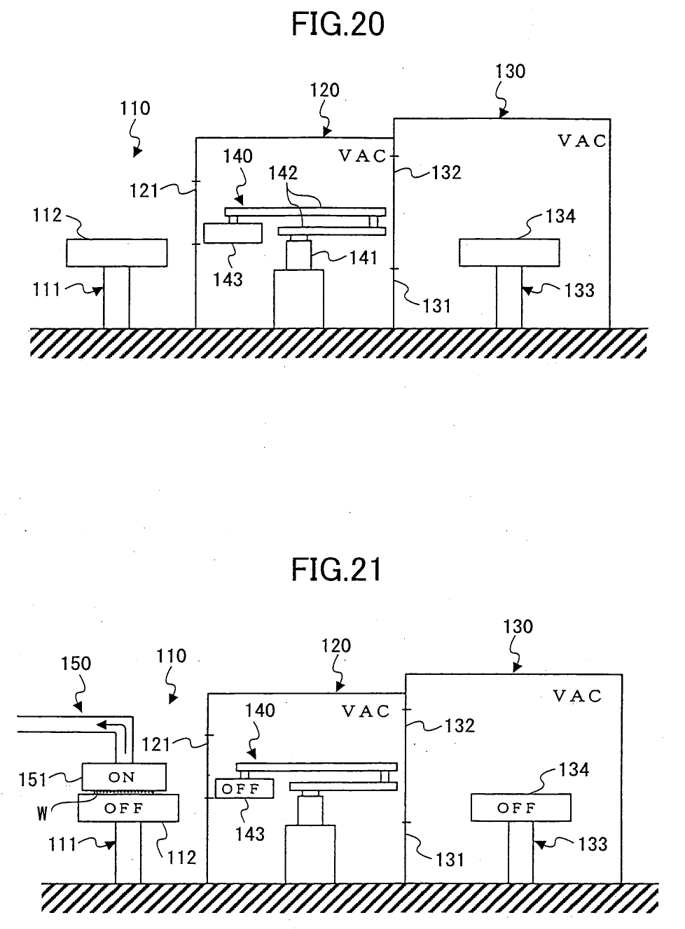

Next, a description is given of a second embodiment of the present invention. FIG. 20 is a diagram showing a configuration of a processing apparatus used in a method of conveying a substrate that is an embodiment of the present invention.

The processing apparatus is for performing a variety of processes for semiconductor manufacturing on the wafer W, and is composed mainly of a platform 110, a load lock chamber 120, and processing chambers 130. The processing apparatus includes the multiple processing chambers 130 for performing backside etching, dicing, etc., but only one of the processing chambers 30 is shown in the drawings for convenience of graphical representation.

The platform 110 includes a stage 111 common to the multiple processing chambers 130. The wafer W, after being processed in one of the processing chambers 130, is attached to the stage 111 provided to the platform 110, and thereafter, is conveyed to the next processing chamber 130. This platform 110 is placed in an air atmosphere (ATM).

A vacuum chuck 112 for attaching the wafer W is provided to the stage 111 provided to the platform 110. The vacuum chuck 112 is connected to a suction device that is not graphically represented. When the wafer W is attached, the wafer W is sucked by the suction device, so that the wafer W is held by the vacuum chuck 112 (the suction force serves as a force to hold the wafer W).

The load lock chamber 120 is connected to a vacuum device that is not graphically represented so that the load lock chamber 120 can have a predetermined reduced pressure atmosphere (hereinafter referred to as VAC) inside. Further, a shutter 121 is provided to the wall of the load lock chamber 120 opposite the platform 110. The shutter 121, which can be opened and closed, hermetically seals the load lock chamber 120 in the closed state. Accordingly, the load lock chamber 120 can have the VAC as described above even with the shutter 121. A conveyor 140 is provided inside the load lock chamber 120.

The conveyor 140 is formed of, for instance, a robot with multiaxial degrees of freedom having an elevation part 141 and an arm part 142. An electrostatic chuck 143 is provided to the end portion of the arm part 142. The electrostatic chuck 143 attracts the wafer W so that the wafer W adheres thereto by a Coulomb force generated by applying voltage to an electrode provided inside (the Coulomb force serves as a force to hold the wafer W).

The elevation part 141 moves the arm part 142 up and down. The arm part 142 moves the electrostatic chuck 143 horizontally. Thereby, the conveyor 140 can move the electrostatic chuck 143 to any position.

In the processing chamber 130, for instance, a plasma etching device that is not graphically represented is provided, so that backside etching that performs etching on the back face (the side with no circuits) of the wafer W to reduce its thickness is performed. The processing chamber 130 is connected to the vacuum device that is not graphically represented so that the processing chamber 130 can have a predetermined VAC (reduced pressure atmosphere) inside. Further, a stage 133 for attaching the wafer W is provided inside the processing chamber 130.

The stage 133 includes an electrostatic chuck 134. Like the electrostatic chuck 143, the electrostatic chuck 134 also attracts the wafer W so that the wafer W adheres thereto by a Coulomb force generated by applying voltage to an electrode provided inside (the Coulomb force serves as a force to hold the wafer W).

Further, the processing chamber 130 and the load lock chamber 120 are hermetically separated by a partition wall 131. A shutter 132 that can be opened and closed is provided to the partition wall 131. In its closed state, the shutter 132 hermetically seals the load lock chamber 120.

Accordingly, the processing chamber 130 can have the VAC even with the shutter 132. Further, the load lock chamber 120 communicates with the processing chamber 130 with the shutter 132 being open.

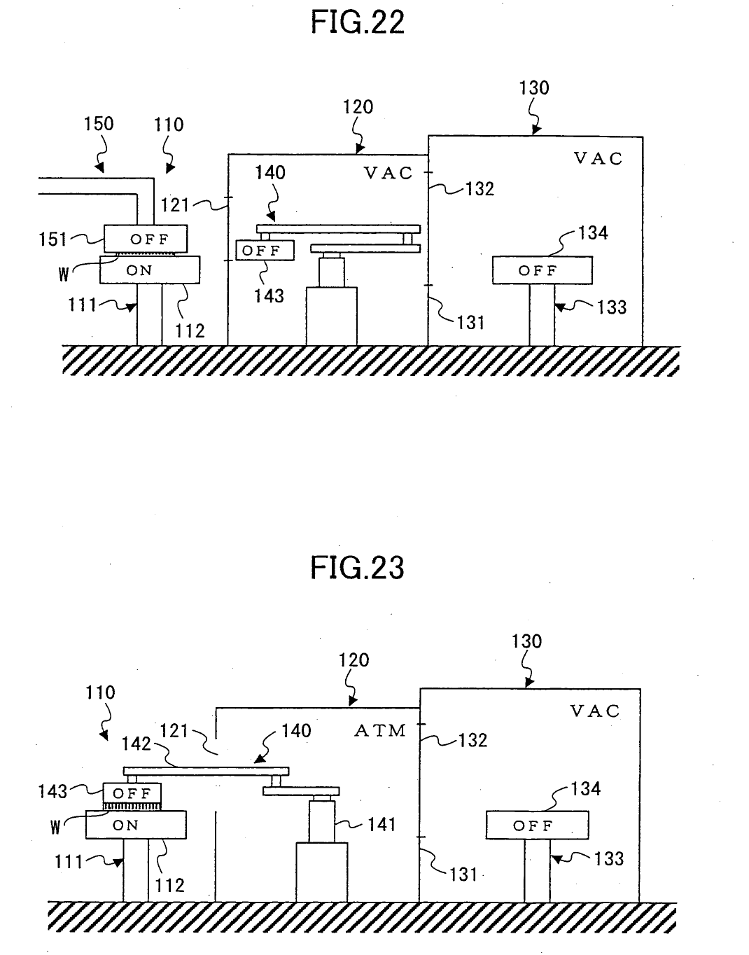

Next, a description is given, with reference to FIGS. 21 through 30, of example conveyance in which the wafer W is conveyed from the platform 110 to the processing chamber 130 in the processing apparatus of the above-described configuration.

In FIGS. 21 through 30, in each of the chucks 112, 134, and 143, “OFF” indicates a state where its driving is stopped so that no force to hold the wafer W is generated, and “ON” indicates a state where it is being driven so that a force to hold the wafer W is generated.

FIG. 21 shows a state where the wafer W whose backgrinding, a process previous to backside etching performed in the processing chamber 130, is completed is attached to the stage 111 of the platform 110 by a transfer arm 150. The transfer arm 150 has a vacuum chuck 151 on its end.

The wafer W, whose thickness is reduced by backgrinding, is held against the vacuum chuck 151 by suction force, and is attached on the vacuum chuck 112 of the stage 111. At this point, no pressure reduction is performed in the vacuum chuck 112 of the stage 111, so that no vacuum suction adhesion force is generated in the vacuum chuck 112. Further, neither the electrostatic chuck 134 nor the electrostatic chuck 143 is driven, so that no holding force is generated. Further, the shutters 121 and 132 are closed, so that each of the chambers 120 and 130 has the VAC. Further, the conveyor 140 is on standby in the load lock chamber 120.

When the wafer W is attached on the vacuum chuck 112 as described above, the vacuum chuck 112 is started so as to start to suck the wafer W. In this state, the vacuum chuck 151 still maintains the holding of the wafer W. Then, after the vacuum chuck 112 turns ON so that the suction of the wafer W is started, the suction of the wafer W by the vacuum chuck 151 of the transfer arm 150 is stopped (OFF). Thereby, the wafer W is transferred from the vacuum chuck 151 of the transfer arm 150 to the vacuum chuck 112 of the stage 111 so as to be held by the vacuum chuck 112.

By the way, the wafer W reduced in thickness by backgrinding is reduced in mechanical strength, and metal interconnections are provided with high density on its circuit-formation face. Accordingly, a substantial difference in stress is generated between its front and back, so that the wafer W is likely to warp.

However, by employing a method that drives the vacuum chuck 112 (ON) to hold the wafer W against the vacuum chuck 112 while the vacuum chuck 151 (the transfer arm 150) is holding the wafer W, and thereafter cancels the holding of the wafer W by the vacuum chuck 151 (OFF) at the time of transferring the wafer W from the transfer arm 150 to the stage 111 as in this embodiment, a state where the holding force of either the vacuum chuck 151 or the vacuum chuck 112 is constantly applied to the wafer W is maintained.

Therefore, it is possible to prevent warping or curving from occurring to the wafer W and maintain the flatness of the wafer W at the time of transferring the wafer W from the transfer arm 150 to the stage 111 of the platform 110. When the wafer W is transferred from the vacuum chuck 151 to the vacuum chuck 112, the vacuum chuck 151 is separated from the wafer W to move again to a backgrinding device.

Meanwhile, in the case where it is necessary to hold the wafer W on the platform 110 for a predetermined period of time in relation to, for instance, time required in the backside etching in the processing chamber 130, the wafer W may be held mechanically between the vacuum chuck 112 and the vacuum chuck 151 when the vacuum chuck 151 is attached on the wafer W on the vacuum chuck 112.

That is, in the above-described embodiment, when the wafer W sucked to adhere to the vacuum chuck 151 is attached on the vacuum chuck 112, the vacuum chuck 112 is turned ON while the vacuum chuck 151 is ON so as to prevent warping etc. from occurring to the wafer W. On the other hand, when the wafer W sucked to adhere to the vacuum chuck 151 is attached on the vacuum chuck 112, the wafer W is held mechanically between the vacuum chuck 112 and the vacuum chuck 151, and thereafter, the suction of the vacuum chuck 151 is stopped (OFF).

In the above-described configuration, a holding force is also applied constantly to the wafer W. Therefore, it is possible to prevent warping or curving from occurring to the wafer W, and accordingly, to maintain the flatness of the substrate. Since the holding is mechanical, the suction device for driving the vacuum chuck 151 and the vacuum chuck 112 can be stopped. Accordingly, it is possible to reduce running costs.

In order to convey the wafer W from the platform 110 to the processing chamber 130, the vacuum chuck 112 is started (ON) so as to suck and hold the wafer W while the wafer W is being held mechanically between the vacuum chuck 112 and the vacuum chuck 115. Next, the transfer arm 150 is moved, so that the wafer W is held by the stage 111.

When the wafer W is held by the stage 111, the shutter 121 opens after the ATM is created in the load lock chamber 120. Then, the conveyor 140 (the elevation part 141 and the arm part 142) is driven so that the electrostatic chuck 143 is moved onto (attached on) the wafer W held by the stage 111 as shown in FIG. 23. At this point, the electrostatic chuck 143 is in an undriven state (OFF) where no voltage is applied thereto, and the shutter 132 is closed so that the processing chamber 130 has the VAC inside.

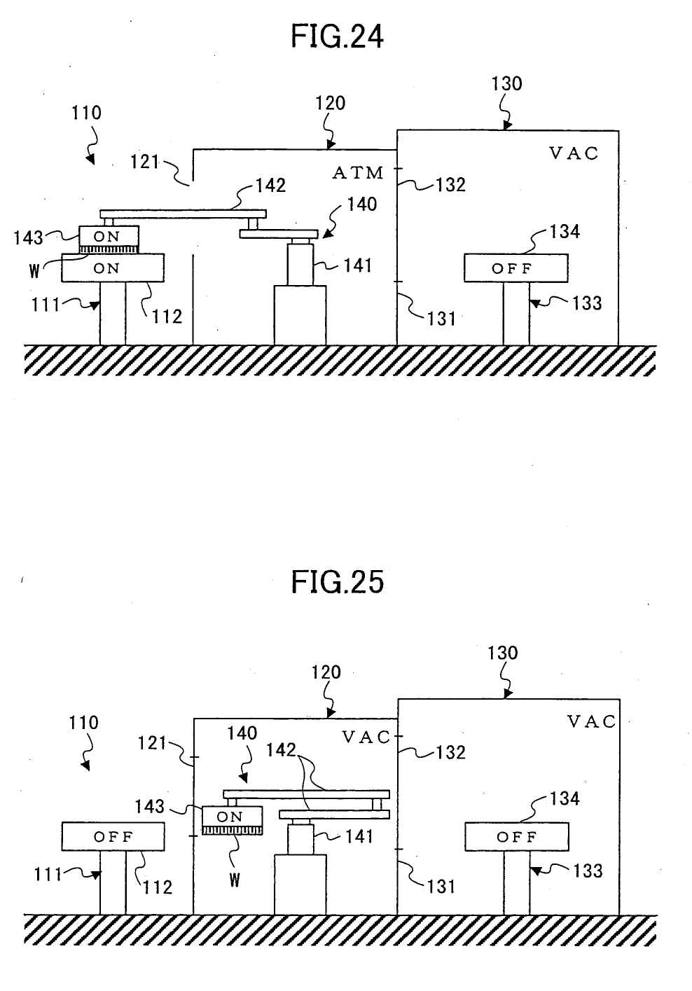

When the electrostatic chuck 143 is attached on the wafer W as described above, voltage is applied to the electrostatic chuck 143, so that the electrostatic chuck 143 is started (ON) so as to start the attraction of the wafer W by a Coulomb force as shown in FIG. 24. In this state, the vacuum chuck 112 still maintains the holding of the wafer W.

After the electrostatic chuck 143 turns ON so that the attraction of the wafer W by the electrostatic chuck 143 is started, the suction of the wafer W by the vacuum chuck 112 of the stage 111 is stopped (OFF). Thereby, the wafer W is transferred from the vacuum chuck 112 of the stage 111 to the electrostatic chuck 143 of the conveyor 140 so as to be held by the electrostatic chuck 143.

As described above, in this embodiment, by employing a method that drives the electrostatic chuck 143 (ON) to hold the wafer W against the electrostatic chuck 143 while the vacuum chuck 112 (the stage 111) is holding the wafer W, and thereafter cancels the holding of the wafer W by the vacuum chuck 112 at the time of transferring the wafer W from the vacuum chuck 112 of the stage 111 to the electrostatic chuck 143 of the conveyor 140, a state where the holding force of either the vacuum chuck 112 or the electrostatic chuck 143 is constantly applied to the wafer W is maintained.

Therefore, it is possible to prevent warping or curving from occurring to the wafer W and maintain the flatness of the wafer W at the time of transferring the wafer W from the stage 111 to the electrostatic chuck 143 of the conveyor 140.

When the wafer W is transferred to the electrostatic chuck 143 as described above, the conveyor 140 is driven to draw the wafer W inside the load lock chamber 120 as shown in FIG. 25. When this drawing is completed,;the shutter 121 is closed, and the load lock chamber 120 is caused to have substantially the same VAC as in the processing chamber 130. At this point, the wafer W is held against the electrostatic chuck 143 by a Coulomb force (an electrostatic force). Accordingly, the electrostatic chuck 143 can also hold the wafer W in the VAC with reliability.

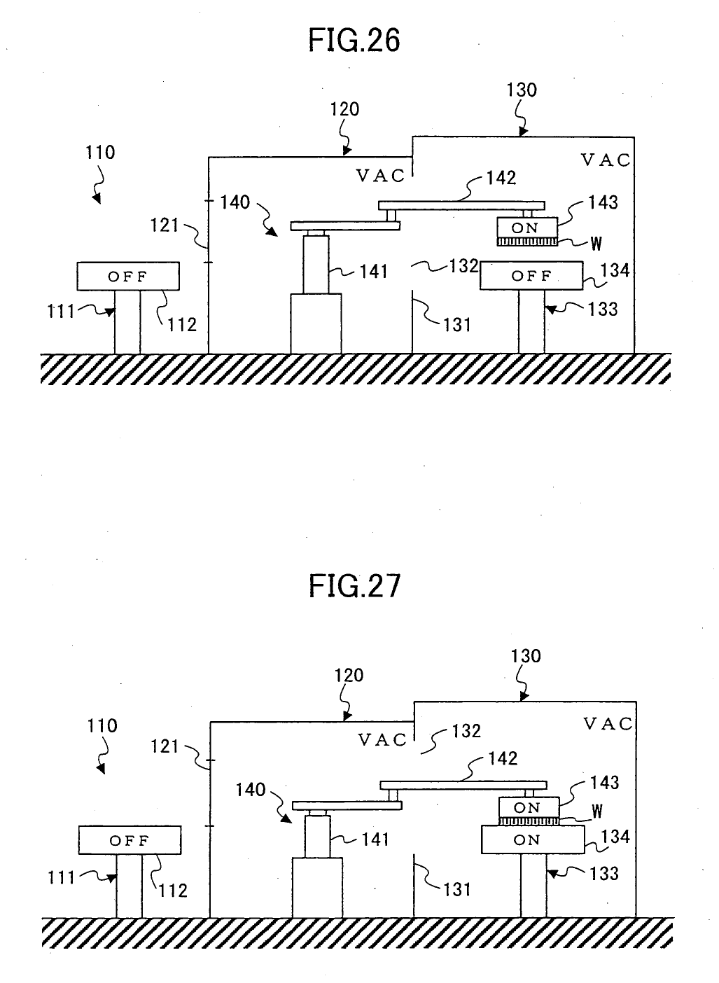

When the load lock chamber 120 has the same VAC inside as the processing chamber 130, the shutter 132 provided to the partition wall 131 separating the load lock chamber 120 and the processing chamber 130 opens. Then, the conveyor 140 is driven again to convey the wafer W held against the electrostatic chuck 143 to a position above the stage 133 of the processing chamber 130 as shown in FIG. 26.

Next, as shown in FIG. 27, the conveyor 140 attaches the wafer W on the electrostatic chuck 134 of the processing chamber 130. When the wafer W is attached on the electrostatic chuck 134, the electrostatic chuck 134 is started (ON) so as to start to attract the wafer W. In this state, the electrostatic chuck 143 of the conveyor 140 still maintains the holding of the wafer W.

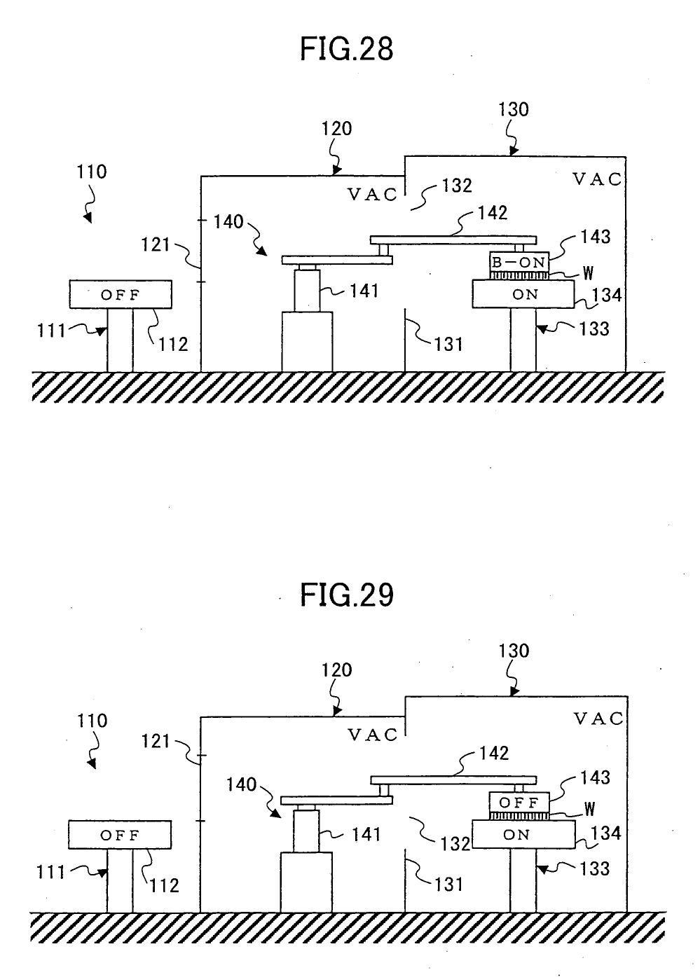

Then, after the electrostatic chuck 134 turns ON so as to start to attract the wafer W, a voltage that is back biasing (a back bias voltage) is applied to the electrostatic chuck 143 as shown in FIG. 28 (indicated as B-ON in FIG. 28). Here, back biasing refers to the application of voltage to the electrostatic chuck 143 so that the electrostatic chuck 143 is charged with a charge (negative charge) different from a charge (positive charge, for instance) at the time of holding the wafer W.

Since the electrostatic chuck 143-holds the wafer W by a Coulomb force, a force to separate the wafer W (repulsive force) is generated in the electrostatic chuck 143 by applying a back bias voltage thereto. The repulsive force by the back biasing urges the wafer W toward the electrostatic chuck 134, so that it is ensured that the wafer W is transferred from the electrostatic chuck 143 to the electrostatic chuck 134.

Generally, in the case of an electrostatic chuck, all electric charges are not dissipated immediately after the application of voltage is stopped. Accordingly, a predetermined period of time is required before the electrostatic chuck loses the power to hold the wafer W completely. This results in loss of time in transferring the wafer W, thus causing a decrease in throughput.

However, by applying a back bias voltage to the electrostatic chuck 143 at the time of transferring the wafer W from the electrostatic chuck 143 to the electrostatic chuck 134 as in this embodiment, it can be ensured that the wafer W is transferred easily from the electrostatic chuck 143 to the electrostatic chuck 134 in a short period of time. Thereby, the throughput of the conveying of the wafer W can be improved.

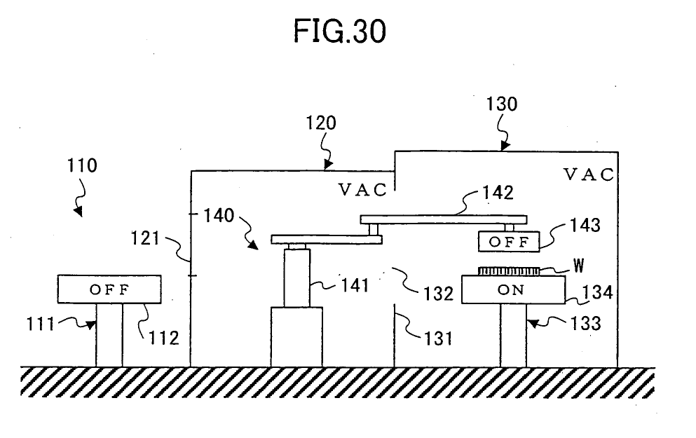

When the wafer W is transferred from the electrostatic chuck 143 to the electrostatic chuck 134, the application of back bias voltage to the electrostatic chuck 143 is stopped (OFF) as shown in FIG. 29, and then, the conveyor 140 is driven so that the electrostatic chuck 143 is separated from the wafer W (see FIG. 30) so as to move again into the load lock chamber 120. Then, the shutter 132 is closed, so that backside etching is performed on the wafer W using the plasma etching device in the processing chamber 130.

As described above, a method that drives the electrostatic chuck 134 (ON) so as to hold the wafer W against the electrostatic chuck 134 while the electrostatic chuck 143 (the conveyor 140) is holding the wafer W, and thereafter cancels the holding of the wafer W by the electrostatic chuck 143 (OFF) is also employed at the time of transferring the wafer W from the electrostatic chuck 143 to the electrostatic chuck 134.

Thereby, a state where the holding force of either the electrostatic chuck 143 or the electrostatic chuck 134 is constantly applied to the wafer W is also maintained at the time of transferring the wafer W from the electrostatic chuck 143 to the electrostatic chuck 134. Therefore, it is possible to prevent warping or curving from occurring to the wafer W and maintain the flatness of the wafer W at the time of transferring the wafer W from the conveyor 140 to the stage 133 of the processing chamber 130.

In the above-described second embodiment, the first base recited in CLAIMS corresponds to the stage 111, and the first substrate holding mechanism corresponds to the vacuum chuck 112. Further, the second base recited in CLAIMS corresponds to the stage 133, and the second substrate holding mechanism corresponds to the electrostatic chuck 134. Further, the conveyor recited in CLAIMS corresponds to the conveyor 140, and the third substrate holding mechanism corresponds to the electrostatic chuck 143. However, the present invention is not limited to the above-described embodiment, and is widely applicable as a conveyor conveying the wafer W.

1. A method of conveying a substrate from a first base including a first substrate holding mechanism and a first fluid jetting mechanism to a second base including a second substrate holding mechanism using a conveyor including a third substrate holding mechanism and a second fluid jetting mechanism, the method comprising:
the conveyor attaching the third substrate holding mechanism to the substrate with the first substrate holding mechanism holding the substrate;
driving the third substrate holding mechanism so as to hold the substrate by the conveyor while the first base is holding the substrate, and thereafter canceling the holding of the substrate by the first substrate holding mechanism and jetting out fluid from the first fluid jetting mechanism;
conveying the substrate from the first base to the second base and attaching the substrate to the second substrate holding mechanism; and
driving the second substrate holding mechanism so as to hold the substrate by the second base while the third substrate holding mechanism is holding the substrate, and thereafter jetting out fluid from the second fluid jetting mechanism and canceling the holding of the substrate by the third substrate holding mechanism.

2. A method of conveying a substrate from a first base including a first substrate holding mechanism and a first fluid jetting mechanism to a second base including a second substrate holding mechanism using a conveyor including a third substrate holding mechanism and a second fluid jetting mechanism, the method comprising:
the conveyor attaching the third substrate holding mechanism to the substrate with the first substrate holding mechanism holding the substrate;
driving the third substrate holding mechanism so as to hold the substrate by the conveyor while the first base is holding the substrate, and thereafter canceling the holding of the substrate by the first substrate holding mechanism and jetting out fluid from the first fluid jetting mechanism;
conveying the substrate from the first base to the second base and attaching the substrate to the second substrate holding mechanism;
driving the second substrate holding mechanism so as to hold the substrate by the second base while the third substrate holding mechanism is holding the substrate, and thereafter jetting out fluid from the second fluid jetting mechanism and canceling the holding of the substrate by the third substrate holding mechanism; and
cleaning the third substrate holding mechanism provided to the conveyor.

3. A method of conveying a substrate from a first base including a first substrate holding mechanism and a first fluid jetting mechanism to a second base including a second substrate holding mechanism using a conveyor including a third substrate holding mechanism and a second fluid jetting mechanism, the method comprising:
the conveyor attaching the third substrate holding mechanism to the substrate with the first substrate holding mechanism holding the substrate;
driving the third substrate holding mechanism so as to hold the substrate by the conveyor while the first base is holding the substrate, and thereafter canceling the holding of the substrate by the first substrate holding mechanism and jetting out fluid from the first fluid jetting mechanism;
conveying the substrate from the first base to the second base and attaching the substrate to the second substrate holding mechanism; and
driving the second substrate holding mechanism so as to hold the substrate by the second base while the third substrate holding mechanism is holding the substrate, and thereafter jetting out fluid from the second fluid jetting mechanism and canceling the holding of the substrate by the third substrate holding mechanism,
wherein the substrate is held by the first substrate holding mechanism after being subjected to backgrinding.

4. A method of conveying a substrate from a first base including a first substrate holding mechanism and a first fluid jetting mechanism to a second base including a second substrate holding mechanism using a conveyor including a third substrate holding mechanism and a second fluid jetting mechanism, the method comprising:
the conveyor attaching the third substrate holding mechanism to the substrate with the first substrate holding mechanism holding the substrate;
driving the third substrate holding mechanism so as to hold the substrate by the conveyor while the first base is holding the substrate, and thereafter canceling the holding of the substrate by the first substrate holding mechanism and jetting out fluid from the first fluid jetting mechanism;
conveying the substrate from the first base to the second base and attaching the substrate to the second substrate holding mechanism;
driving the second substrate holding mechanism so as to hold the substrate by the second base while the third substrate holding mechanism is holding the substrate, and thereafter jetting out fluid from the second fluid jetting mechanism and canceling the holding of the substrate by the third substrate holding mechanism; and
cleaning the third substrate holding mechanism provided to the conveyor,
wherein the substrate is held by the first substrate holding mechanism after being subjected to backgrinding.

5. The method of conveying the substrate as claimed in claim 1, wherein:
at least one of the first and second bases and the conveyor are provided in reduced pressure chambers, and the substrate holding mechanism provided to the base provided in the reduced pressure chamber and the third substrate holding mechanism are electrostatic chucks.

6. The method of conveying the substrate as claimed in claim 2, wherein:
at least one of the first and second bases and the conveyor are provided in reduced pressure chambers, and the substrate holding mechanism provided to the base provided in the reduced pressure chamber and the third substrate holding mechanism are electrostatic chucks.

7. The method of conveying the substrate as claimed in claim 3, wherein:
at least one of the first and second bases and the conveyor are provided in reduced pressure chambers, and the substrate holding mechanism provided to the base provided in the reduced pressure chamber and the third substrate holding mechanism are electrostatic chucks.

8. The method of conveying the substrate as claimed in claim 4, wherein:
at least one of the first and second bases and the conveyor are provided in reduced pressure chambers, and the substrate holding mechanism provided to the base provided in the reduced pressure chamber and the third substrate holding mechanism are electrostatic chucks.

9. A method of conveying a substrate from a first base including a first substrate holding mechanism to a second base including a second substrate holding mechanism using a conveyor including a third substrate holding mechanism, the method comprising:
the conveyor attaching the third substrate holding mechanism including a first substrate including an electrostatic chuck and a second fluid jetting mechanism to the substrate with the first substrate holding mechanism holding the substrate;
driving the third substrate holding mechanism so as to hold the substrate by the conveyor while the first base is holding the substrate, and thereafter canceling the holding of the substrate by the first substrate holding mechanism;
conveying the substrate from the first base to the second base and attaching the substrate to the second substrate holding mechanism; and
driving the second substrate holding mechanism so as to hold the substrate by the second base while the third substrate holding mechanism is holding the substrate, and thereafter jetting out fluid from the second fluid jetting mechanism and canceling the holding of the substrate by the third substrate holding mechanism.

10. A method of conveying a substrate to a base including a first substrate holding mechanism using a conveyor including a second substrate holding mechanism, the method comprising:
the conveyor attaching the substrate on the first substrate holding mechanism of the base with the second substrate holding mechanism holding the substrate;
releasing the holding of the substrate by the second substrate holding mechanism after mechanically holding the substrate between the first substrate holding mechanism and the second substrate holding mechanism; and
driving the first substrate holding mechanism so as to hold the substrate by the base while the substrate is being held mechanically between the first and second substrate holding mechanisms.

11. The method of conveying the substrate as claimed in claim 9, wherein the substrate is held by the first substrate holding mechanism after being subjected to backgrinding.

12. The method of conveying the substrate as claimed in claim 9, wherein:
at least one of the first and second bases and the conveyor are provided in reduced pressure chambers, and the substrate holding mechanism provided to the base provided in the reduced pressure chamber is an electrostatic chuck.

13. The method of conveying the substrate as claimed in claim 12, wherein:
in transferring the substrate between the substrate holding mechanism provided to the base provided in the reduced pressure chamber and the third substrate holding mechanism, voltage is applied to the electrostatic chuck from which the substrate is transferred so that an electrostatic force is generated in a direction to separate the substrate therefrom.
